(19) United States
(12) Patent Application Publication
(10) Pub. No.: US 2008/0290332 A1
(43) Pub. Date: Nov. 27, 2008

(54) Floor Jack-Jack Stand Combined

(76) Inventor: Karl Zetterlund, Houston, TX (US)

Correspondence Address: WILSON DANIEL SWAYZE, JR., 3804 CLEARWATER CT., PLANO, TX, 75025, US

(21) Appl. No.: 11/753,901

(22) Filed: May 25, 2007

(51) Int. Cl. B60P 1/48

(52) U.S. Cl. 254/8 B

(57) ABSTRACT

A floor jack for lifting a vehicle includes a first hydraulically operated lifting arm for connecting to the vehicle, a hydraulic lever to lift the first hydraulically operated lifting arm and a locking device to lock the first hydraulically operated lifting arm. The floor jack includes a side plate to cooperate with the first hydraulically operated lifting arm and the floor jack includes a biasing device to bias the locking device. The biasing device includes a spring and the floor jack includes a second hydraulically operated lifting arm. The hydraulically operated lifting arm includes a curved end, and the curved end includes notches to cooperate with the locking device.

### FIELD OF THE INVENTION

The present invention is directed to an improvement in wheeled floor jacks and is especially concerned with an attachment for or accessory to such wheeled floor jacks.

### BACKGROUND OF THE INVENTION

Wheeled floor jacks have been in use for many years to raise and lower automobiles. Large capacity models of heavy duty construction and weight have been the mainstay of professional car repair shops and service stations. Smaller, e.g. 1, 11/4, and 11/2 ton capacity floor jacks of lighter weight and construction have been marketed for some time for use by such repair shops for road service and general use. Due to their small size and light weight, the general public has adapted them for home use as well and also as a spare jack to be used by the car owner and carried in the trunk of the car.

Examples of such conventional floor jacks are depicted in U.S. Pat. Nos. 4,018,421 and 4,131,263. Numerous other manufacturers and marketers, including those marketed under the Blackhawk trademark, are available.

Such wheeled floor or service jacks, while generally quite useful and popular, do suffer from some drawbacks.

Typically, the floor jacks do not provide a locking mechanism in order to prevent the floor jack from losing hydraulic pressure causing the floor jack and the automobile from collapsing back to the surface. If the user is caught under the automobile under these conditions there is the possibility of injury and even death from the weight of the collapsing automobile.

This invention relates to an hydraulic floor jack of the type which rolls on the floor to engage under a vehicle and lift it.

Existing floor jacks are used in conjunction with a jack stand under the car for safety. However, many people do not use the jack stand and if the floor jack should develop a leak, the floor jack can lower quickly trapping or killing the user.

### SUMMARY

A floor jack for lifting a vehicle includes a first hydraulically operated lifting arm for connecting to the vehicle, a hydraulic lever to lift the first hydraulically operated lifting arm and a locking device to lock the first hydraulically operated lifting arm.

The floor jack includes a side plate to cooperate with the first hydraulically operated lifting arm and the floor jack includes a biasing device to bias the locking device.

The biasing device includes a spring and the floor jack includes a second hydraulically operated lifting arm.

The hydraulically operated lifting arm includes a curved end, and the curved end includes notches to cooperate with the locking device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the floor jack of the present invention; FIG. 2 illustrates a side view of the floor jack of the present invention with the locking device disengaged from the notches;

FIG. 3 illustrates a side view of the floor jack of the present invention with the hydraulically operated lifting arm retracted;

FIG. 4 illustrates a sectional view of the floor jack of the present invention;

FIG. 5 illustrates a partial view of the hydraulic lever of the floor jack of the present invention.

### DETAILED DESCRIPTION

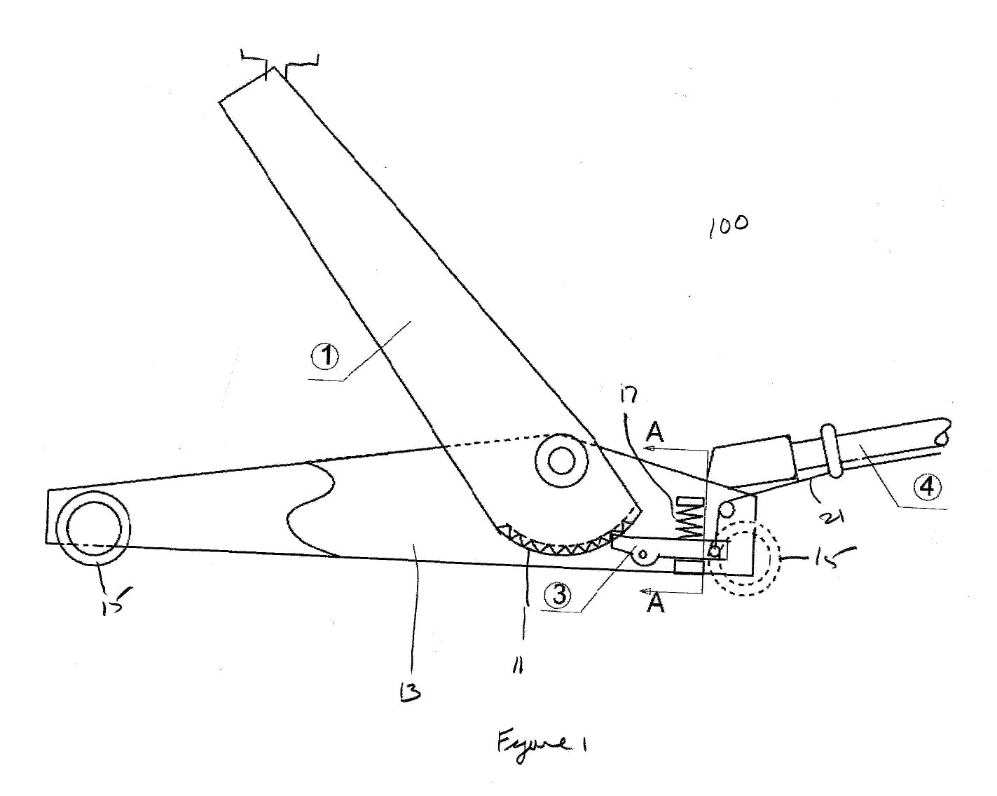

FIG. 1 illustrates the floor jack 100 of the present invention. The floor jack 100 is formed of a rigid frame and includes a pair of opposing side plates 13 having a pair of wheels 15 at each end of the opposing side plates 13. The floor jack 100 additionally includes an hydraulically operated lifting arm 1 pivotably mounted in each side plate 13 so that the hydraulically operating lifting arm 1can rotate and raise a vehicle. The hydraulically operating lifting arm 1is lifted by a hydraulic lever 4.

The hydraulically operating lifting arm 1 includes a curved end which includes notches 11 to cooperate with the locking device 3. The end of the locking device 3 is shaped to fit within the notch 11 so that the locking device 3 can prevent the hydraulically operated lifting arm 1 from retracting while in the raised position. Consequently, if the floor jack 100 should develop a hydraulic leak, the hydraulically operated lifting arm 1 will not descend.

The locking device 3 is connected to a biasing device 17 which may be a spring or other suitable device to bias the locking device 3 so that the locking device 3 is not removed or disengaged from the notch 11. The opposing end of the locking device 3 is attached to an connecting wire 21 to lift the opposing end of the locking device 3 by the user in order to disengage or remove the end of the locking device 3 from the notch 11 so that the hydraulically operated lifting arm 1 may be safely lowered. FIG. 2 illustrates that the connecting wire 21 has lifted the opposing end of the locking device 3 to disengage the locking device 3 from the notch 11. The connecting wire 21 has overcome the biasing of the biasing device 17 so that locking device 3 can be disengage of the notch 11. Consequently, the hydraulically operated lifting arm 1 can be safely lowered to a position which is essentially parallel to the side plates 13.

FIG. 3 illustrates that the hydraulically operated lifting arms 1 has been lowered to a position which is essentially parallel to the side plates 13. The biasing device 12 has biased the locking device 3 so that the end of the locking device 3 engages a notch 11 of the hydraulically operated lifting arm 1.

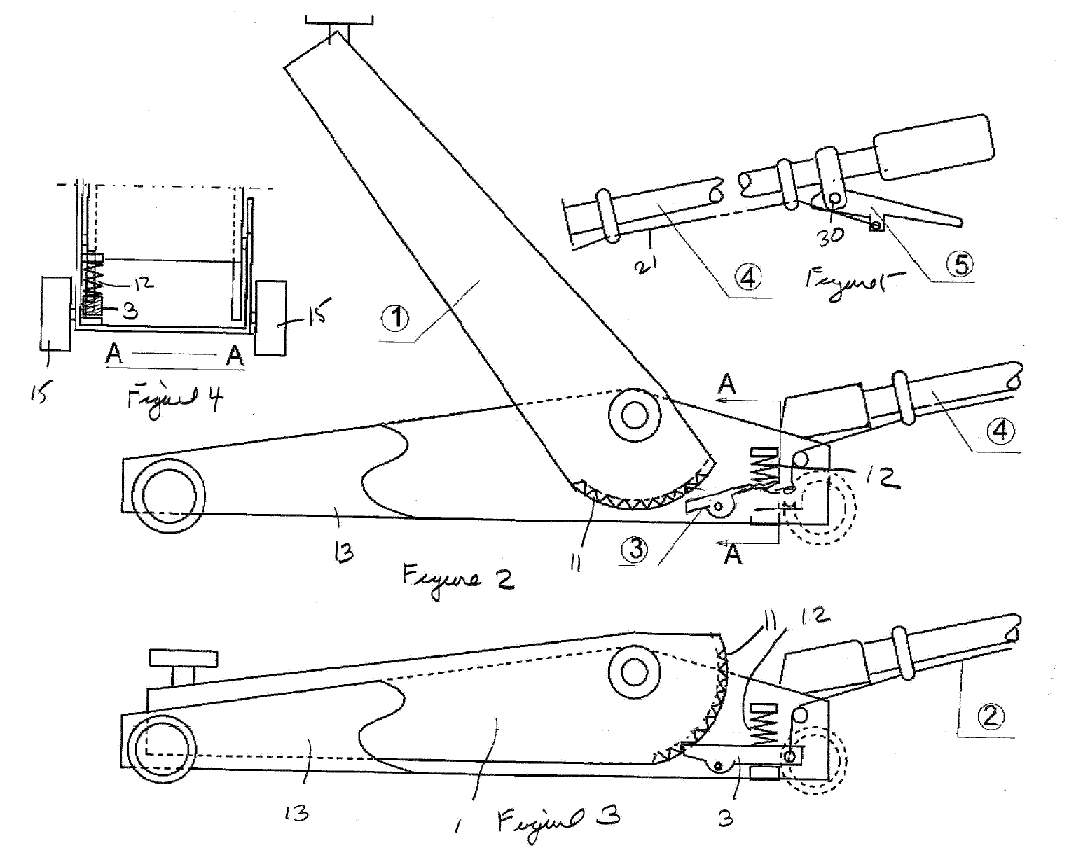

FIG. 4 illustrates a sectional view of section A-A which shows the locking device 3 and the biasing device 17.

FIG. 5 illustrates a portion of the hydraulic lever 4 which includes a release lever 5 which is connected to the connecting wire 21. The release lever 5 pivots about a pivot point 30 to pull or release the connecting wire 21 which in turn releases the locking device 3.

As the hydraulically operated lifting arms 1 are raised by the hydraulic lever 4 the locking device 3 will sequentially engage a notch 11 along the curved end of the hydraulically operated lifting arm 1.

If the hydraulically operated lifting arm 1 prematurely comes down, then the locking device 3 will lock into a notch 11 and hold the hydraulically operated lifting arm 1 in place

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A floor jack for lifting a vehicle, comprising:
a first hydraulically operated lifting arm for connecting to the vehicle;
a hydraulic lever to lift the first hydraulically operated lifting arm;
a locking device to lock the first hydraulically operated lifting arm.

2) A floor jack for lifting a vehicle as in claim 1, wherein the floor jack includes a side plate to cooperate with the first hydraulically operated lifting arm.

3) A floor jack for lifting a vehicle as in claim 1, wherein the floor jack includes a biasing device to bias the locking device.

4) A floor jack for lifting a vehicle as in claim 3, wherein the biasing device includes a spring.

5) A floor jack for lifting a vehicle as in claim 1, wherein the floor jack includes a second hydraulically operated lifting arm.

6) A floor jack for lifting a vehicle as in claim 3, wherein the hydraulically operated lifting arm includes a curved end.

7) A floor jack for lifting a vehicle as in claim 6, wherein the curved end includes notches to cooperate with the locking device.

8) A method for operating a floor jack for lifting a vehicle, comprising:
connecting a first hydraulically operated lifting arm to the vehicle;
lifting the first hydraulically operated lifting arm with a hydraulic lever;
locking the first hydraulically operated lifting arm with a locking device.

9) A method for operating a floor jack for lifting a vehicle as in claim 8, wherein the floor jack includes a side plate to cooperate with the first hydraulically operated lifting arm.

10) A method for operating a floor jack for lifting a vehicle as in claim 1, wherein the method includes the step of biasing the locking device with a biasing device.

11) A method for operating a floor jack for lifting a vehicle as in claim 10, wherein the biasing device includes a spring.

12) A method for operating a floor jack for lifting a vehicle as in claim 8, wherein the floor jack includes a second hydraulically operated lifting arm.

13) A method for operating a floor jack for lifting a vehicle as in claim 8, wherein the hydraulically operated lifting arm includes a curved end.

14) A method for operating a floor jack for lifting a vehicle as in claim 13, wherein the curved end includes notches to cooperate with the locking device.
